(19) United States
(12) Patent Application Publication
(10) Pub. No.: US 2007/0296244 A1
(43) Pub. Date: Dec. 27, 2007

(54) Adjusting system of a motor vehicle for the adjustment of a closing piece for the closing of an opening of a motor vehicle body

(76) Inventor: Guido Borrmann, Dortmund (DE)

Correspondence Address: Jacob Eisenberg, Seerainstrasse 3a, Steckborn, CH-8266, omitted

(21) Appl. No.: 11/474,509

(22) Filed: Jun. 26, 2006

(51) Int. Cl. B60J 5/10

(52) U.S. Cl. 296/146.8

(57) ABSTRACT

An adjusting system of a motor vehicle for the adjustment of a closing part is disclosed. The closing part may be a rear flap, a trunk deck, a sliding or swinging door. The closing part may be adjustable between an opened position and a closed position along a setting range. A body opening of a motor vehicle body is closed in the closed position by a closing part. The adjusting system uses at least two springs to effect the closing. The two springs may be selectively operated over a range of operation settings.

### BACKGROUND OF THE INVENTION

The present invention is directed to an adjusting system of a motor vehicle for the adjustment of a closing piece for the closing of an opening of a motor vehicle body.

Rear flaps of a motor vehicle are held by gas pressure springs in an opened position whereby the gas pressure springs operate against the weight of the rear flap. Often two identical gas pressure springs are provided to evenly support the weight of the car body.

An object of the invention is based upon the further development of an adjusting system of a motor vehicle for the adjustment of a closing piece for the closing of an opening of a motor vehicle body with an electro motive actuation.

An adjusting system of a motor vehicle for the adjustment of a closing piece between an opening position and a closing position is provided according to the invention. The closing piece thereby serves for the closing of a body opening of a motor vehicle body. Such a closing piece may be for example a rear flap, a trunk deck, an engine room deck, a window pane, a sliding door or a swinging door. The closing part is adjustable within a setting range from an opened position to a closed position. The adjusting system thereby comprises several components which are preferably connected in such a way that a compact structure is achieved.

The adjusting system thereby comprises at least two springs which operate differently along the setting range. It is thereby decisive for a different effect that the spring forces in the same adjusting position within the setting range within the common process tolerance are not identical but deviate significantly from one another.

A preferred further embodiment of the invention provides that at least the two springs operate against the gravity of the closing piece. Advantageously, a weight of the closing piece effecting the actuation of the adjusting system can hereby be compensated.

Because it is possible that the force caused by the gravity and retroactive to the actuation is variable setting-dependent, it is provided according to a preferred further embodiment of the invention that the effect of the spring forces is adjusted such that at least the two springs are to the setting-dependent course of the force retroactive to the actuation. The setting dependence of the retroactive force can, for example, be conditioned by changing a length of an arm of a lever or transmission ratios over the setting range. The retro-effect to the actuation can vary according to the constrictive development of the adjusting system, by the location of the motor vehicle or by the ageing of the adjusting system so that no complete but only close compensation of the retroactive forces occurs by the spring forces.

An advantageous embodiment of the invention provides that the springs are connected in series or parallel. If more than two springs are provided, a series as well as a parallel circuit can be provided. A series connection or a parallel connection enables a cooperation of the single spring forces. Advantageously, the effect is again setting range dependent by providing a buffer within the setting range for at least one of the springs connected in series or parallel which limits a further spring path or decouples a spring force from a further setting range. Advantageously, it is thereby provided that the spring forces of the springs accumulate at least within the setting range.

Sealing means for the sealing of a first casing and the second casing are provided according to an advantageous embodiment of the invention. These should seal the casing interior room, particularly against humidity and soiling. Such sealing means may be for example seal rings, fats or preferably elastomers which form one or several seal lips.

To further advantageously develop the invention, control areas for the radial guidance of the fist casing and/or the second casing are provided. These radial guides advantageously enable a support and slide control of the second casing within the first casing. The gliding characteristics of the control areas can preferably be influenced by a two-component-synthetic material.

The first and the second casing preferably comprise the same cross section so that advantageously the second casing is run on bearings moveable within the first casing in a length-wise direction. Advantageously, the first as well as the second casing comprise a circular cross section and are preferably tubular or cylindrical.

Furthermore, the adjusting system preferably comprises a spindle for the relative adjustment of the first casing to the second casing which is arranged within the first casing and/or within the second casing. During an adjustment of the closing piece, the spindle thereby moves relatively to at least one of the two casings in a length-wise direction. An electro motor and a transmission of the adjusting system are attached in the first casing and/or the second casing and connected with the spindle. A force released, for example by an electro motor, and transmitted by a transmission onto the spindle or onto a spindle nut arranged on a spindle operates the connection. Therefore, the actuation from the electro motor and the transmission and the adjusting mechanics, which comprises at least the spindle, are integrated with the first casing and the second casing to a modular unit. Therefore, the electro motor is neither attached at the body nor at the closing piece but arranged together with the adjusting mechanics within the casings sealed against the casing environment.

A part of the first casing or the second casing is advantageously allocated to at least one of the springs in double function of a function for control.

A casing interior wall forms for example a support as well as a spiral spring. In another advantageous embodiment of the invention, a bearing for the attachment of the first casing and/or the second casing at the body respectively at a closing piece is arranged, whereby the bearing is preferably a pivot bearing and/or a drag bearing.

In the following the invention is further explained in example of embodiments according to the drawings.

Thereby showing:

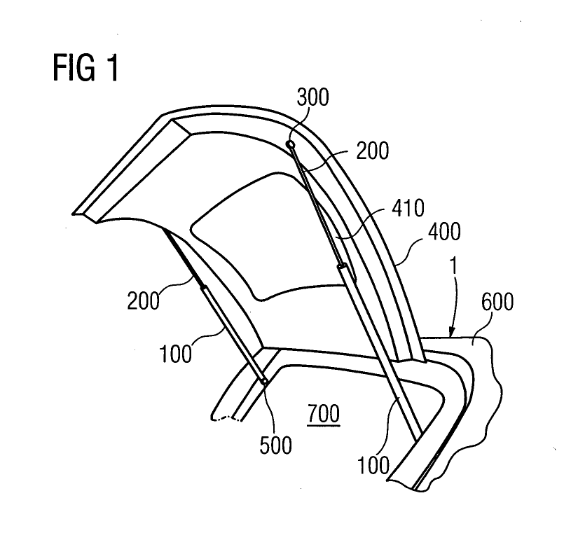

FIG. 1 is a view of a rear flap in an opened position,

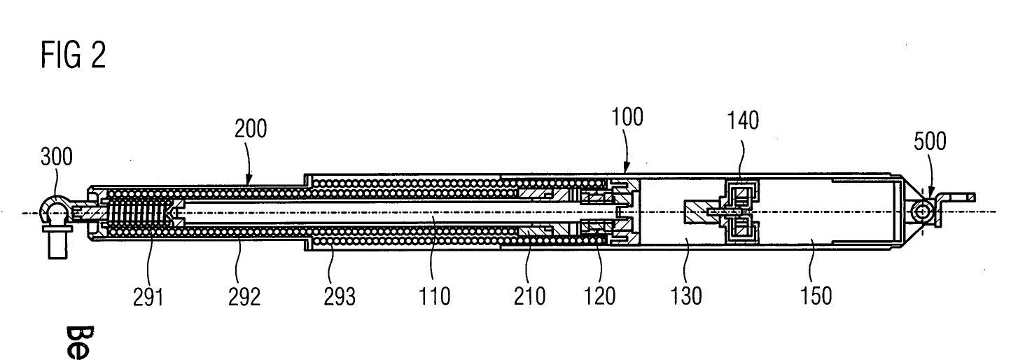

FIG. 2 is a sectional view through a rear flap adjusting system, and

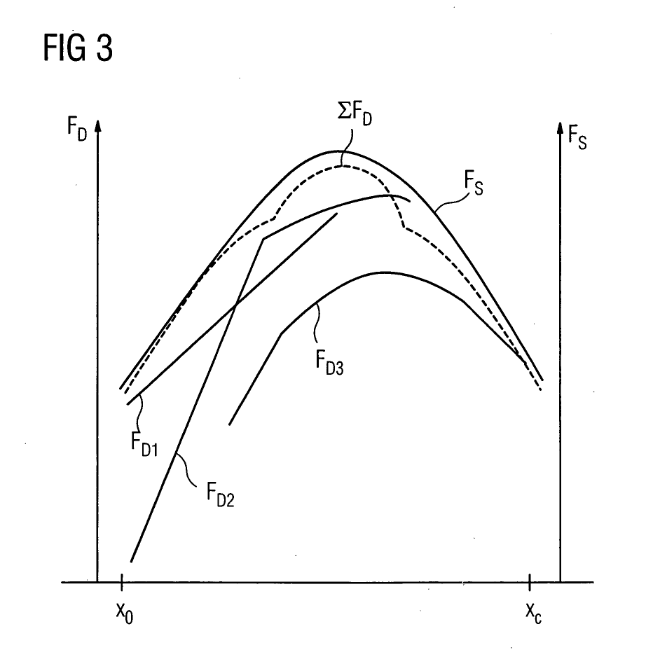

FIG. 3 is a diagram for the presentation of force retroactive to the motor and the spring forces.

A tree-dimensional detailed view of a motor vehicle 1 with an opened rear flap 400 as a closing piece is shown in FIG. 1. The body 600 and body opening 700 in body 600 of the motor vehicle 1 being lockable through the rear flap 400 are only shown schematically. Apart from an external metal sheet, the shown rear flap 400 comprises—if necessary—a lower-able window pane 410 and an adjusting system with a first casing 100, a second casing 200, a first bearing 300 and a second bearing 500. Such adjusting systems are shown in FIG. 1 which effects together an adjustment of the rear flap 400 between a closed position and an opened position of the rear flap 400.

Further example, embodiments not shown in the figures provide an adjusting system of a motor vehicle for the adjustment of a closing piece other than the rear flap 400. The adjusting system can be particularly used for the adjustment of the trunk deck or a sliding or swinging door to close a body opening of a motor vehicle.

An adjusting system in detailed view is shown in FIG. 2. The adjusting system comprises a first casing 100 extending oblong along a lengthwise direction in the form of an external tube 100. A second casing 200, also in the form of an external tube 200, also extends oblong along the same length-wise direction. The second external tube 200 comprises a smaller cross section than the first external tube 100 and the second external tube 200 is adjustably arranged at least partially within the first external tube 100 in the above mentioned length-wise direction. This construction can also be described as telescope-like.

The first external tube 100 is attached on the side of the body while the second external tube 200 is attached on the side of the rear flap. A respective bearing 300, 500 is provided in the shown embodiment for the attachment. The first bearing 500 which is fixated at the first external tube 100 hereto preferably comprises two universal (cardan) joints. The second bearing 300 which is fixated at the second external tube 200 which hereto preferably comprises a ball socket.

An electro motor 150, a brake 140, a two-stage transmission 130, particularly a planetary transmission and an adjusting mechanism with a six-geared spindle 110 and a spindle nut 210 running on bearings rotationally on a spindle 110, are arranged at least partially within the first external tube 100. These elements shown in FIG. 2 thereby influence the dynamic effects chain from an electro motor 150 to the adjustment of the rear flap 400. A brake 140 operates between the electro motor 150 and the transmission 130 which enables a cancellation of the braking effect by a manual dynamic force on the rear flap 400 as well as by an electro-motive force of the electro motor 150. The brake 140 is thereby integrated within the first external tube 100 between the electro motor 1 50 and the transmission 130.

If the electro motor 150 is for example controlled by a power field effect transistor not shown in FIG. 2, the moment transmitted by the electro motor 150 minus a lower friction of the brake 140 is released to the two-stage transmission 130. The moment transmitted by the transmission 130 is released to the spindle 110 which turns in dependence of the current delivery of the electro motor,

The spindle nut 210 is adjusted in an axial direction by the turn of the spindle 110. The spindle nut 210 is thereby connected with the second external tube 200 in such a way that the second external tube 200 is adjusted in the same direction with the spindle nut 210.

The spindle nut 210 is hereto preferably fixated at the second external tube 200 or at a piece firmly connected to the second external tube.

Several springs 291, 292 and 293 are arranged within the two external tubes 100, 200 whereby at least two of the springs 291, 292 or 293 are connected in series and/or at least two of the springs 291, 292, 293 are connected in parallel. All springs 291, 292 and 293 thereby operate in a length-wise direction to support an opening of the rear flap 400 against the weight of the rear flap 400. At least a guiding element for the control of the spring motion is preferably provided. The spring 291, 292 and 293 can be put in a space-saving way into each other by their diameters.

The springs 291, 292 and 293 should thereby imitate in their method of their circuit the active load on the actuation 150. The external force is thereby equalized and the motor 150 can be selected to be smaller. A capsule is inserted between the springs for a series connection. If the springs 291, 292 and 293 are lapped inverse into each other, an interlocking of the windings of two springs 291, 292 and 293 is avoided. If the springs 291, 292 and 293 are not protected against buckling or if the control by the capsule 800 is not sufficient, as shown in the presented example embodiment, an additional internal and external tube 280 is used for the control of the springs 291, 292 or 293. A wire retainer (cage) can take over the same function as a capsule 800. The capsule 800 can be produced from a synthetic or metal. Additionally, an inwards-lying gas spring could be used as a spring which is for example formed by a sealing cap of the spindle 110 in its not-deventilated conductor tube.

The course of the active forces is schematically shown in FIG. 3. A force Fs, with a maximum in approximately a center of the setting range between the opened position xc and a closed position xc retroactive on the actuation 150, is depicted by way of a simplified embodiment. The force retroactive on the actuation 150 is therefore setting-range-dependant.

To approximately compensate the force Fs′ retro activeness on the actuation 150, the spring forces Fd1, Fd2 and Fd3 are depicted and arranged to operate against the force Fs′ retro activeness on the actuation. The three springs 291, 292 and 293 thereby comprise characteristic curve lines deviating from on another. The sum ΣEd of the spring forces Fd1, Fd2 and Fd3 is shown as a dotted line in FIG. 3. Not each spring 291, 292 or 293 in each adjusting position contributes to the sum Fd of the spring forces Fd1, Fd2 and Fd3.

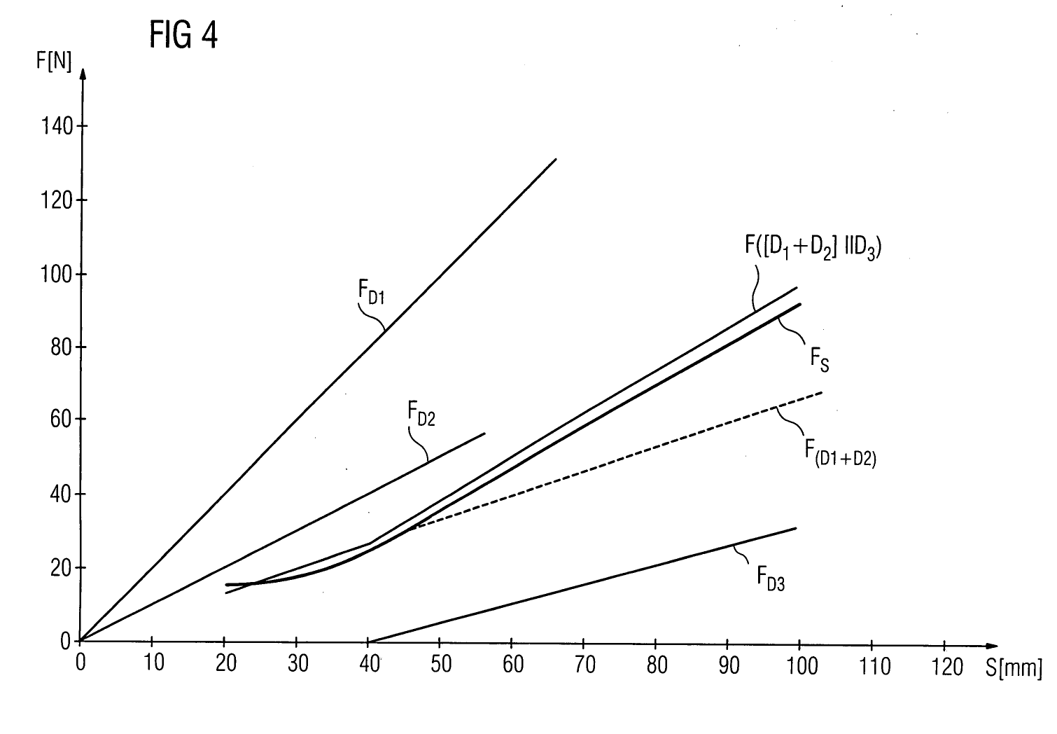

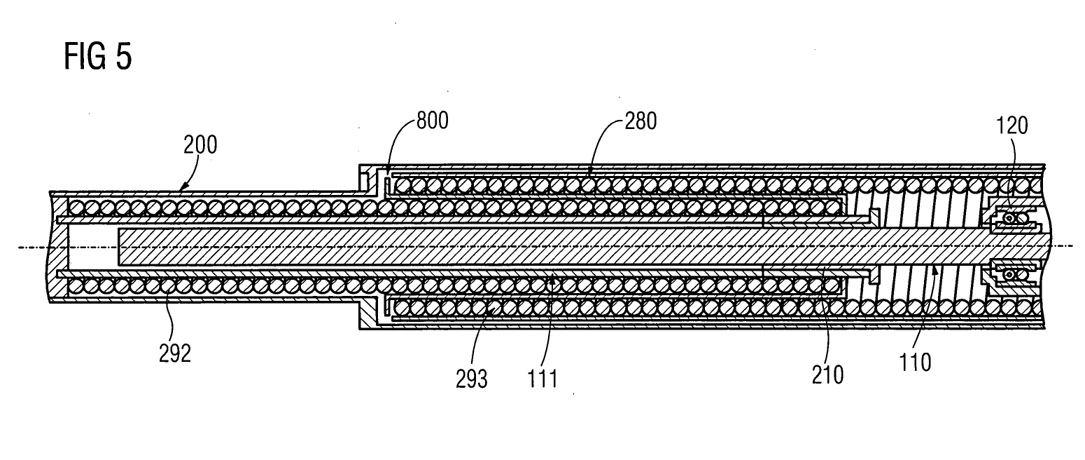

The good force courses are shown for an imitated rear flap in FIG. 4. The shown forces P can vary according to constructive formation of the rear flap. The spring forces Fd1 and Fd2 operate as two springs 292 and 293 connected in series starting from the adjusting point x12 as shown in FIG. 5. The resulting force F (d1+d2) of the springs 292 and 293 connected in series is indicated by dotted lines. A further spring is connected in parallel in addition to the springs 292 and 293 connected in series. The spring force Fd3 of this additional spring operates from the starting point x3. The resulting force ([D1+D2]¦¦D3) is also shown in FIG. 4. The force Fs thereby indicates the force retroactive on the actuation. The retroactive force is approximately compensated for by the connection in series or parallel of the springs, as shown in FIG. 4.

A constructive example embodiment for the forces is depicted in FIG. 4, a sectional view through the rear flap adjustable actuation is shown in FIG. 5 as a cut-out. A capsule 800 is provided for the connection in series of the springs 292 and 293 where both springs support themselves axially. The springs 292 and 293 are thereby sectional arranged in an interleaved and space-saving manner. A conductor tube 280 and a conductor tube 111 orientated towards tie spindle are provided as a means for the control of the springs 292 and 293, which avoids a contact between the spring 292 and the spindle 110.

1. An adjusting system of a motor vehicle for the adjustment of a closing part, wherein:
said closing part is at least one of a rear flap, a trunk deck, a sliding or swinging door,
said closing part is adjustable between an opening position and a closing position along a setting range, and
said system comprises at least two springs arranged to variably operate along a setting range such that a body opening of a motor vehicle body a closed position is closed.

2. The adjusting system according to claim 1, wherein said at least two springs comprise adjustable spring forces (FD1, FD2, FD3) whose different effects are adjustable to setting-range-dependent course of a force retroactive to an actuation.

3. The adjusting system according claim 1, wherein the at least two springs are connected in at least one of series and parallel.

4. The adjusting system according to claim 1, wherein the springs forces accumulate, at least section-wise, within the setting range.

5. The adjusting system according to claim 1, wherein the spring force of at least one spring operates only in one section of the setting range.

6. The adjusting system according to claim 1, wherein at least one spring is prestressed.

7. The adjusting system according to claim 1, wherein the at least two springs comprise different spring characteristic curve lines.

8. The adjusting system according to claim 1, wherein, the at least two springs are arranged in an actuation casing.

9. The adjusting system according to claim 1, wherein, the at least two springs operate against the gravity of the closing part.

10. The adjusting system according to claim 1, wherein at least one of the at least two springs is a pressure spring.

11. The adjusting system according to claim 1, wherein at least one of the at least two springs is a tension spring.

12. The adjusting system according to claim 1, wherein at least one of the at least two springs is a spiral spring.

13. The adjusting system according to claim 1, wherein at least one the at least two springs is a gas pressure spring.

14. The adjusting system according to claim 1, wherein the at least two springs are arranged into each other.

15. The adjusting system according to claim 1, wherein at least one spring is led through at least one of a capsule and a tube.

16. The adjusting system according to claim 1, wherein two of the at least two spiral springs are wound opposite to each other.

17. The adjusting system according to claim 1, wherein one of the at least two springs is arranged at at least one of within an actuation casing and outside the actuation casing.

18. The adjusting system according to claim 1, wherein the at least two springs connected in series and are connected by a capsule whereby one of the at least two springs is arranged within other of the at least two springs and said one of the at least two springs and said other of the at least two spring are at least partially controlled by the capsule.
